(19) United States
(12) Patent Application Publication
(10) Pub. No.: US 2011/0307392 A1
(43) Pub. Date: Dec. 15, 2011

(54) Concierge Reservation for Services Referral System for Members

(76) Inventor: Russell L. Jenson, Salt Lake City, UT (US)

(21) Appl. No.: 12/797,605

(22) Filed: Jun. 10, 2010

(51) Int. Cl. G06Q 10/00

(52) U.S. Cl. 705/304

(57) ABSTRACT

Concierges at hotels and other establishments are often asked to assist with various reservations for restaurants, transportation services, golf, and other services. This invention is to connect concierges that sign up as members to this system process with service providers that also sign up as members to provide the services. The connection between these members facilitates faster reservations and better information between the concierges and service providers. The member service providers are able to quickly identify and report concierges that refer customers. The placement of reservations and the confirmation of reservations between members facilitate referral commissions that can be paid between members. Members can review transactions online and work together to provide better service to their guests, while understanding the value of working efficiently together.

### FIELD OF THE INVENTION

The invention relates to a system and process of connecting member concierges with member service providers in an online, efficient and effective manner. Thus enabling member concierges and member service providers to provide better services to their guests and better understand the relationship between members. The members will have an incentive to work more effectively with those that refer and provide services to their guests.

### BACKGROUND OF THE INVENTION

Concierge services are usually provided by hotel concierges and concierges at other establishments where guests often need the services provided by concierges. Guests often either call or visit the concierge at their location. Services provided by concierges often include restaurant reservations, transportation arrangements, golf reservations, directions and other requests of the guests.

Concierges often have significant influence with their guests. Guests at hotels are often unfamiliar with local restaurants and other local activities. Concierges can use their local knowledge to better serve these guests with their various requests.

Concierges often provide maps and directions to guests.

Concierges often need to know the distance to various establishments that guests would like to go to.

Concierges often hear back from guests whether the recommendations that they provided were well received or not. Understanding feedback from guests is important and influences future recommendations of the concierge.

The wide availability of the internet has provided many with the ability to search online for answers to questions about local activities and restaurants. The internet can be used to connect people with unique and common interests. The speed of the internet in transmitting data between users is important.

Currently there are often loose arrangements between concierges and service providers to pay referral commission. Often the concierge is dependent on the guest providing a business card or other type information to the service providers in hopes of receiving a referral commission. Phone calls to service providers can be disruptive at busy times. Often service providers prefer reservations through the internet. Sometimes service providers receive referrals from concierges but choose not to acknowledge the referral with any kind payment.

Service providers recognize that concierges have significant influence with guests looking for various services. Service providers want to understand and track the influence concierges have on the guests that may consume services at their establishments.

Service providers know that certain activities may be going on at their establishment, which would significantly impact their capacity to provide services at certain times. Thus these service providers want to be able to effectively communicate and manage the available capacity to service guests at various times.

Often guests would like to see menus, ratings, comments or other information about potential choices of what is available.

Concierges would like to have a web site that can quickly get them information regarding top restaurants, golf courses, transportation and other types of service providers within their area or near a significant point of interest. Information could include distance to establishment, map, menus, past guest comments, pictures or any other information.

### SUMMARY OF THE INVENTION

This invention is to connect concierges that sign up as members to this system with service providers that sign up as members to this system.

All members agree to the terms of the system invention provider. Key terms include using the system honestly, with full disclosure, confirming reservations in a timely manner, following the payment terms of referral commissions. Any member not following the rules can have their account removed from the system.

Connecting many member concierges with many member service providers is efficient and effective. Both types of members can have beneficial relationships with more members by using the invention system.

This invention uses to internet as part of its process to connect members that share interests in servicing their guests. Specifically member concierges referring guests to member service providers.

Members must log in to the invention system with their unique identifier.

The speed of the internet and the ability of the system to authenticate members, are important in allowing members to safely communicate between members.

Member concierges and member service providers input key profile information into the invention system when they become members. This information is stored within the system invention and is available for use within the system.

Both member concierges and member service providers are able to maintain their respective profile within the system.

Member concierges are able to view availability of and make reservations for services within the system with member service providers. Because member profile information was previously entered into the system invention, making reservations is very fast for the member concierge. The individual only needs to enter key information about the guest to complete the reservation.

Member concierges are able to search for various types of service providers based a variety of attributes stored in the invention system.

Type of member service provider attributes stored within the system include types of restaurants, distance from concierge, price range, and many other factors.

Member service providers receive information regarding reservations immediately through the system, email, fax or text message. Members have their choice of how they would like to receive notification.

Member concierges are able to track reservations and requests for service that they input in the system. At the same time member service providers are able to track requests from concierges.

Reporting of transactions for both the member concierges and member service providers is important. This builds a trusting relationship between the members and allows the system invention to work for them and their guests.

Member concierges are often associated with a hotel or other sponsoring establishment. This relationship between the individual member concierge and the sponsor of the concierge is stored in the system and is available as an attribute to be searched and reported on.

The member concierge is able to input guests' comments about their recommendations into the system. These recommendations can be useful references for future recommendations.

Member service providers want to be able to reward member concierges that refer business to them. This invention with its transaction tracking facilitates the gathering of information necessary to pay referral commissions to member concierges for their referral services.

Member service providers are able to input capacity and other limitations regarding their ability to provide services at certain times.

Member service providers are able to provide added incentives at certain times to further influence and reward referrals.

Member concierges are able to view through the system that there are added incentives to refer guests at different times of the day and generally compare referral commissions between member service providers.

Member concierges are able to use the system to immediately link to member service providers' websites or to stored information within the system. Stored information may include menus, directions, distance and information about the member service provider. This stored information provides faster and more complete service to the guest. Sometimes the guests want to see pictures or other information from the service provider's website.

This system is designed to also work with various types of member service providers. The most common are restaurants, transportation (taxis, limousines, buses . . . ), activities (such as golf or tours) and various other business services.

This system is designed to provide the member concierge with the distance from their hotel or establishment to the member service provider.

Some guests often want to know of restaurants that are away from their hotel but are close to a special point of interest. Special points of interest may include a beach, amusement park, shopping mall, theater, arena or some other point of interest. The guests might be going to this point of interest and want a reservation in that area that is not close to their hotel.

Member service providers have the ability to confirm that a guest did come to their establishment as was expected by the reservation that was made by the member concierge. It is important for the member service providers to either confirm or no/show the reservation.

The system invention based on the member service providers' confirmation of a reservation establishes transactions between the member concierge and member service provider that are eligible for referral commissions between the parties.

If the reservation is not confirmed or is flagged as a no/show, the reservation is not eligible for referral commission. The reservation still is in the system and reports of no/show are available.

The invention system provides the member service providers with reports of confirmed reservations, what the proposed referral commission will be, which concierges provided the referrals and other information about past transactions.

The invention system provides the member concierges with reports regarding confirmed reservations, the status of payment of referral commissions and information about past and upcoming referral commissions.

Members can choose to cancel their membership status with the system provider, but will lose access to the system and all related functionality.

### DESCRIPTION OF THE DRAWINGS

These drawings provide views regarding the general structure and general processes of the invention.

FIG. 1—Data Design of Member System—This figure provides summary information of the core database tables that are critical to this invention. Tables include: concierge member information, service provider member information and information about services provided, combination table that helps match member concierges with member service providers within areas, reservations table that stores information about the reservations created by member concierges and serviced by member service providers, referral commissions billing table to store information about billings to the member service providers and member concierge referral commissions payment table to store information about payments to member concierges.

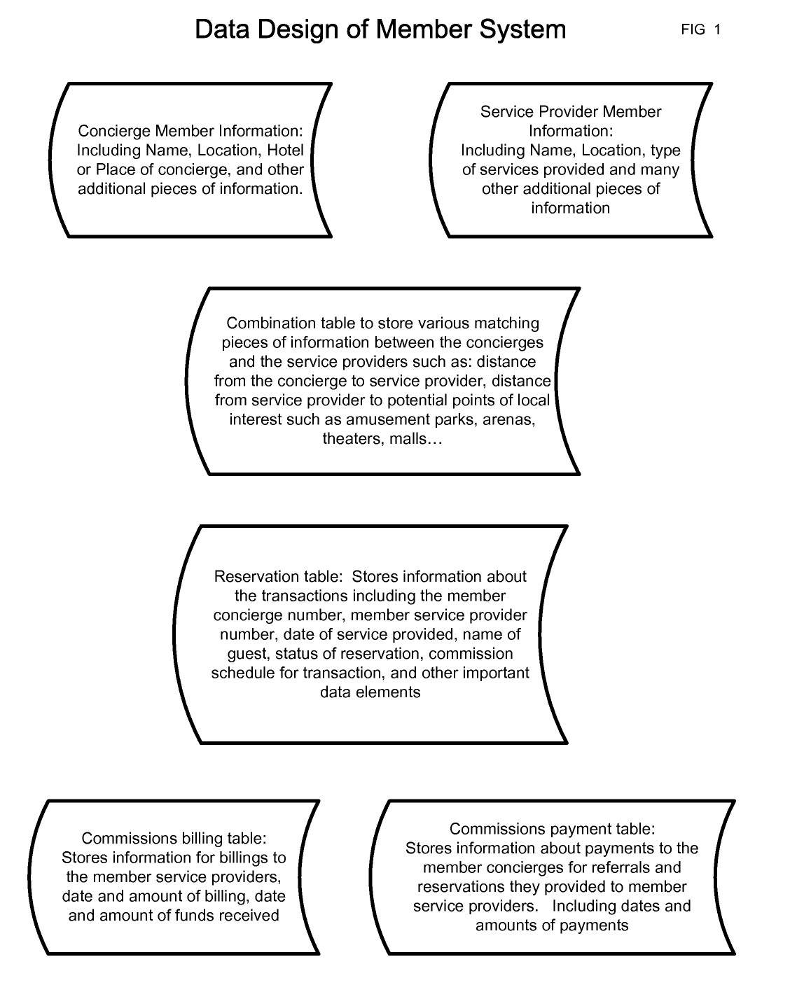

FIG. 2—Member Profile Administration—This figure provides information indicating that members must be logged into the system with a membership. The members need to enter key profile information about them. The system requires a member that is logged into the system to be able to create, update, view or delete reservations or other key data elements of the invention system.

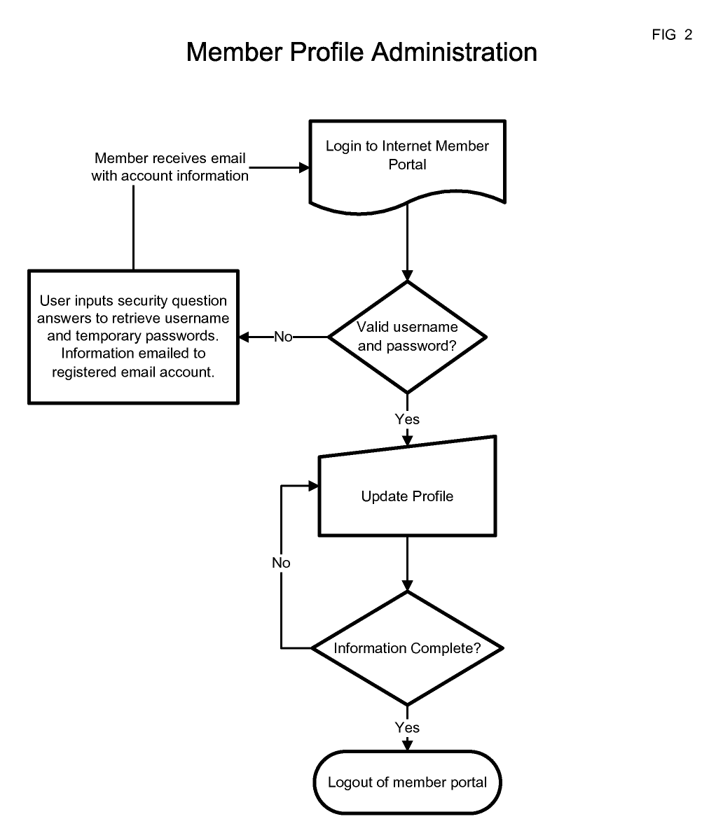

FIG. 3—Concierge Sign-up Process—This figure describes the process to validate member concierges are truly concierges, eligible to sign up, willing to follow the membership rules and provide valid information for their membership record.

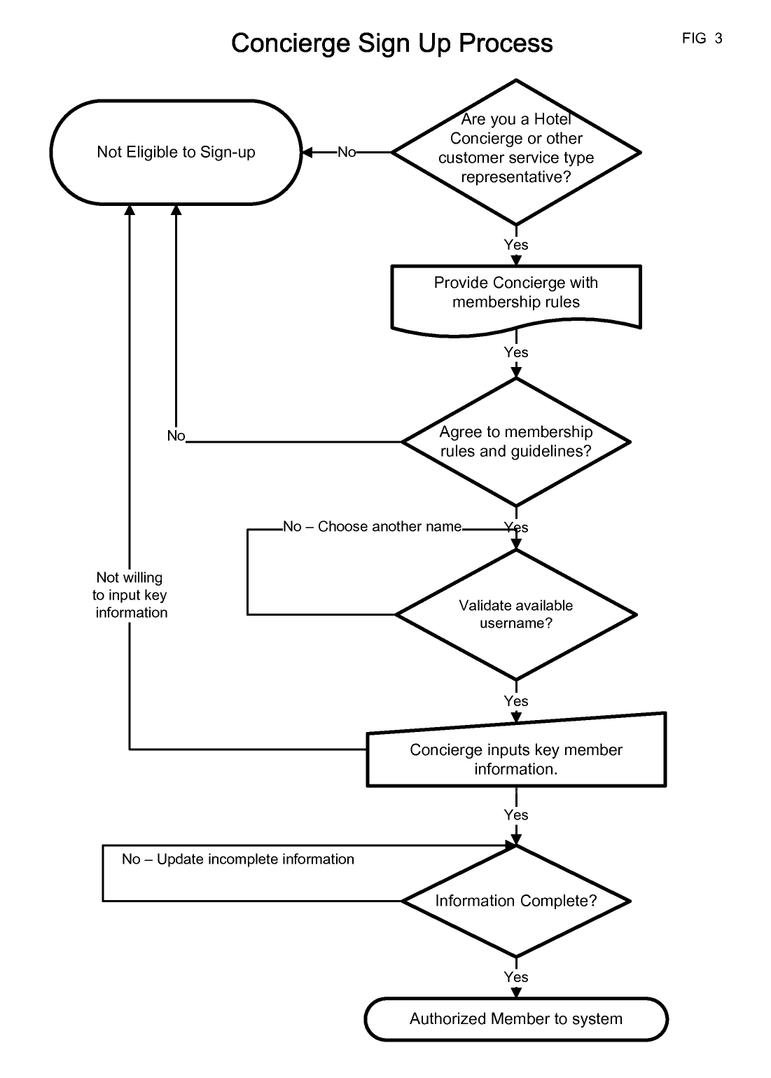

FIG. 4—Service Provider Sign Up Process—The figure describes the process to validate that member service providers are service providers, eligible to sign up, willing to follow membership rules and provide valid information for their membership record.

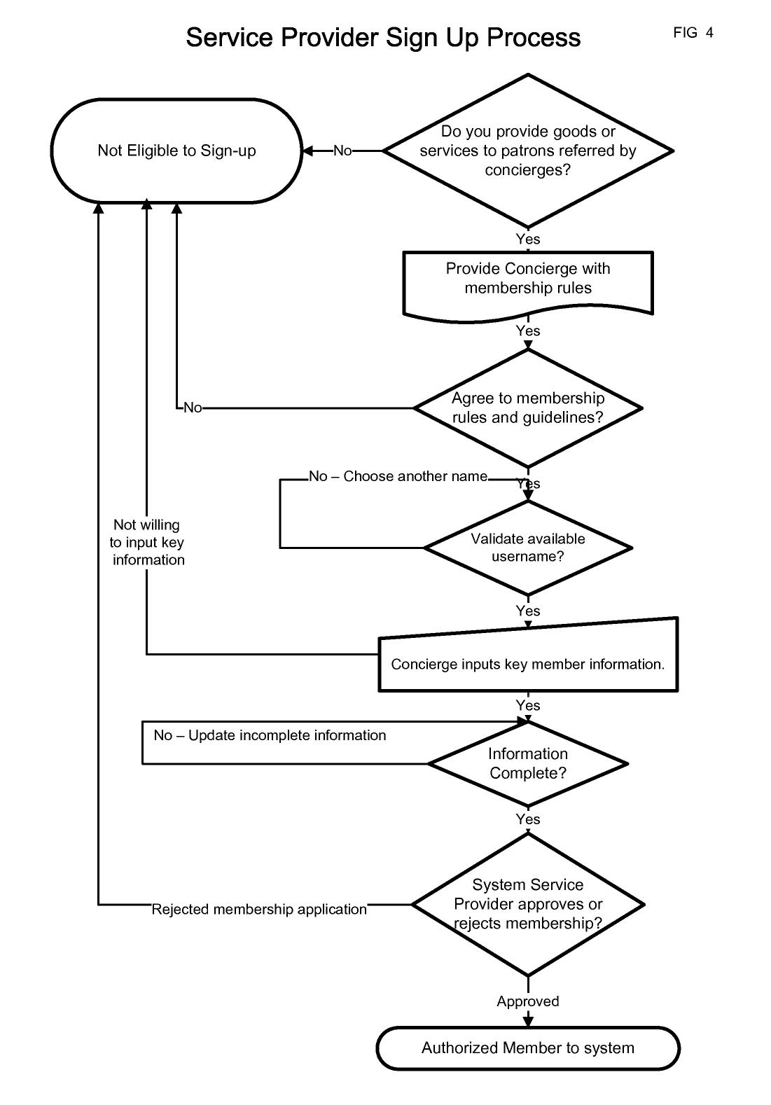

FIG. 5—Restaurant Reservation Process from the Concierges Perspective—This figure describes the process from a guest talking with the member concierge describing their desires, to member concierge logging into the system, checking availability of the desired member services, making a reservation with core information regarding the guest and providing the guest with directions or other information regarding their reservation.

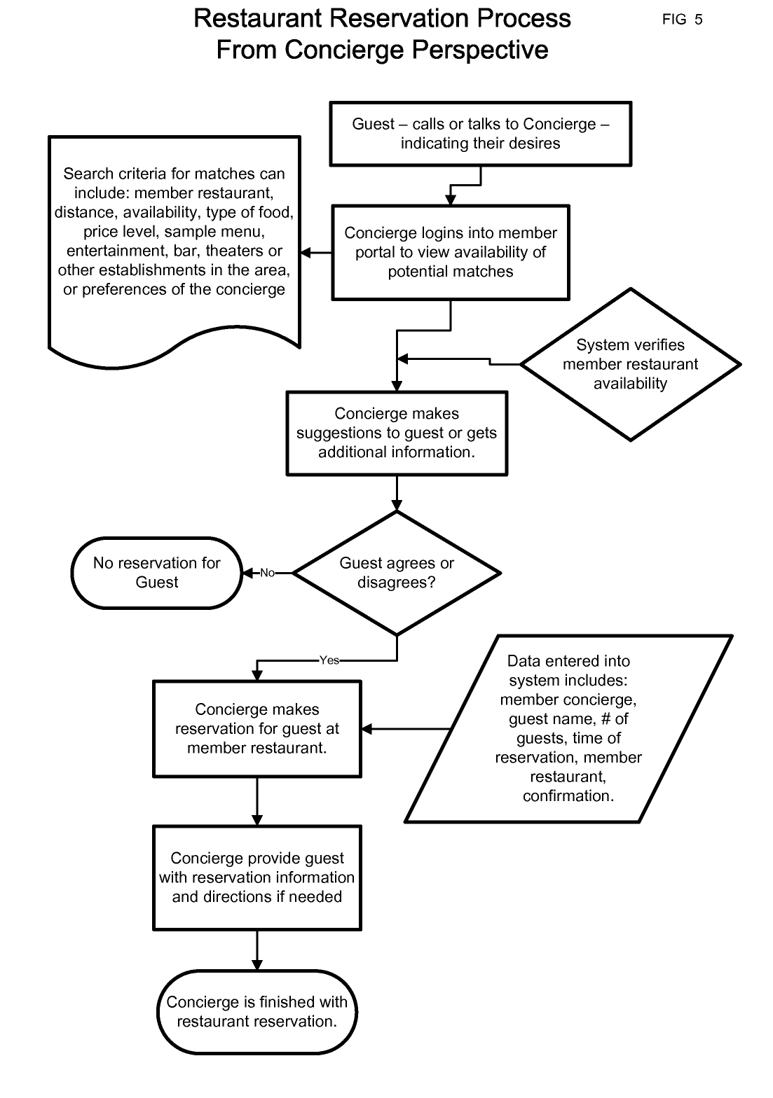

FIG. 6—Restaurant Reservation Process from the Restaurant Perspective—This figure describes how the member restaurant logs into the invention system or provides the invention system with information regarding the member restaurants availability at various times to service member concierges referred guests. The member restaurant receives an electronic reservation through the system indicating key information of the referred guests and time of the reservation. The member restaurant may also receive an email, text message or fax regarding the upcoming reservation. The member restaurant then goes into the invention system to confirm that guests have arrived or not. Confirmation that the guests arrive is critical the referral commission process. Without a confirmation that the guests arrived there is no referral commission.

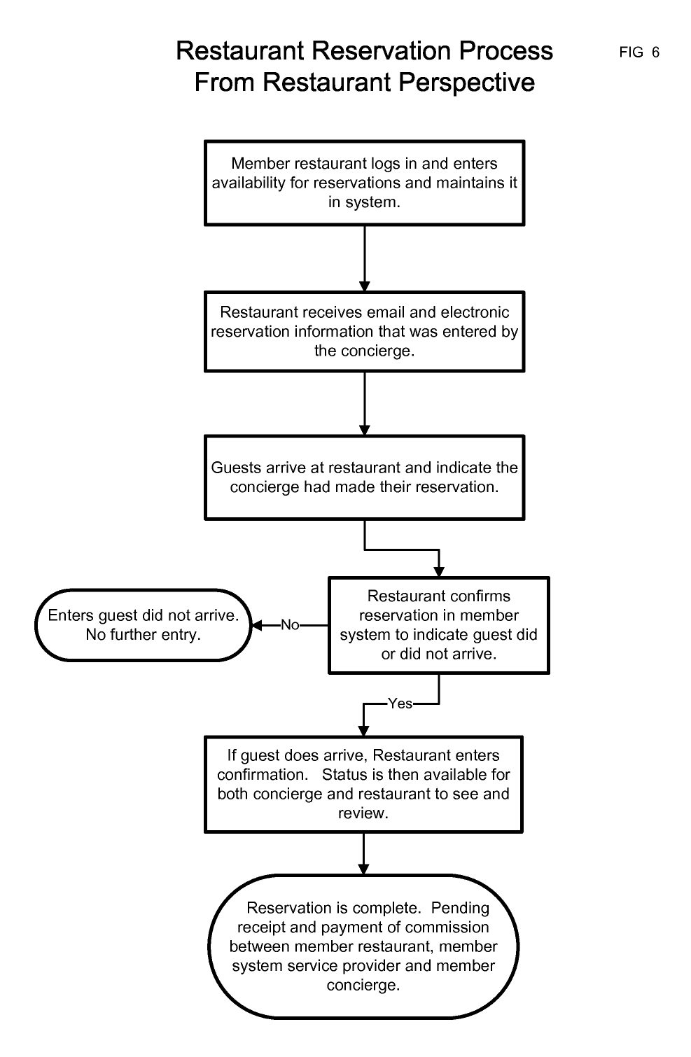

FIG. 7—Referral Commission Process after Reservation and Confirmation of Services—This figure describes that both the member concierge and member service provider are able to review the reservations that have and have not been confirmed. It is in the interests of both member parties for the information to be accurate. This encourages a long ongoing relationship between all the member parties. Only member service providers are able to confirm that guests actually arrived for their reservation. Member service providers are provided information about their pending charges for referral commissions. The invention system works with member service providers to receive payments for referral commissions, after receiving funds from member service providers, the invention system facilitates payments to member concierges.

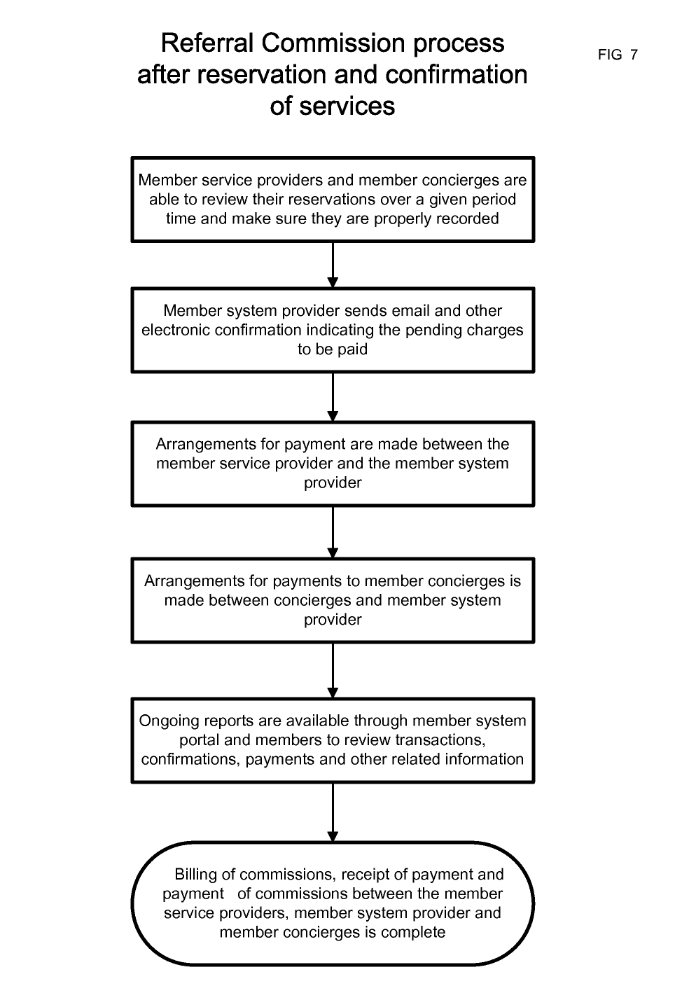

FIG. 8—Transportation Reservation Process from Concierge Perspective—This figure describes the process from a guest talking with the member concierge describing their desires, to member concierge logging into the system, checking availability of the desired member services, making a reservation with core information regarding the guest and providing the guest with directions or other information regarding their reservation. This is very similar to any other reservation process for other services that the member concierge may arrange.

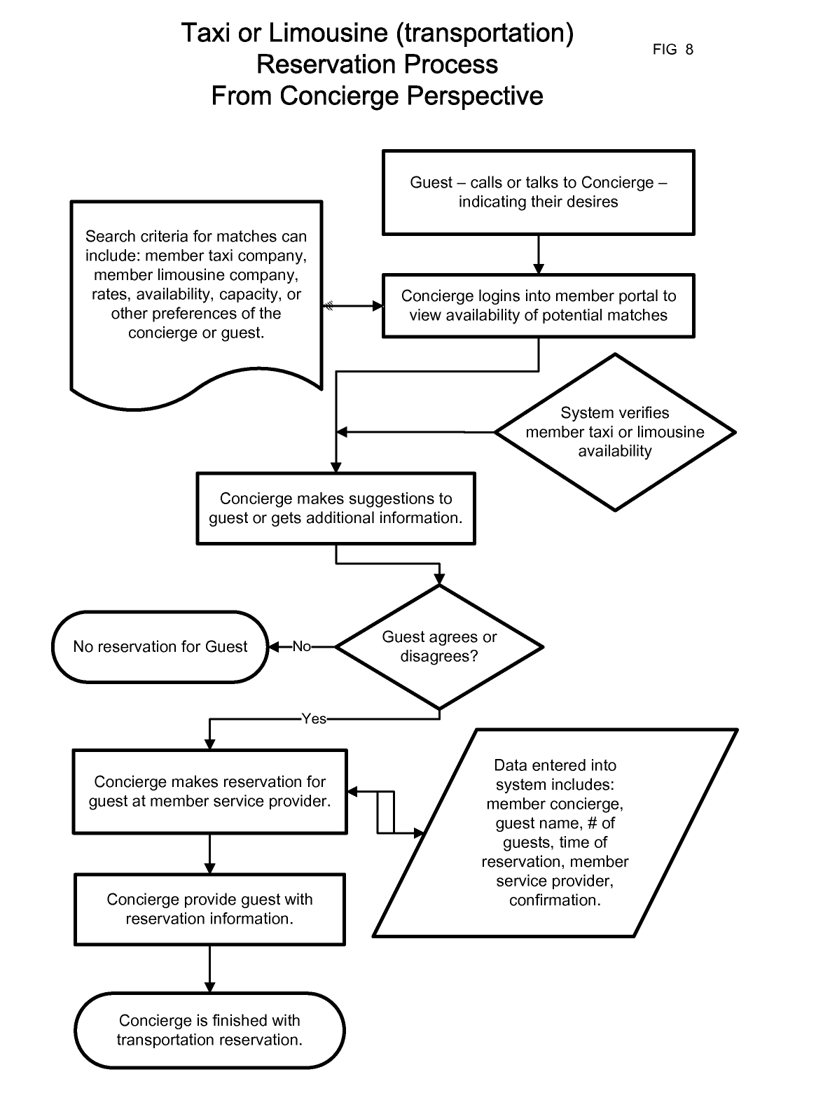

FIG. 9—Transportation Reservation Process from Transportation Perspective—This figure describes how the member transportation provider logs into the invention system or provides the invention system with information regarding availability at various times to service member concierges referred guests. The member transportation provider receives an electronic reservation through the system indicating key information of the referred guests and time of the reservation. The member transportation provider may also receive an email, text message or fax regarding the upcoming reservation. The member transportation provider then goes into the invention system to confirm that guests were picked up or not. Confirmation that the guests were provided services is critical the referral commission process. Without a confirmation that the guests were provided services is no referral commission.

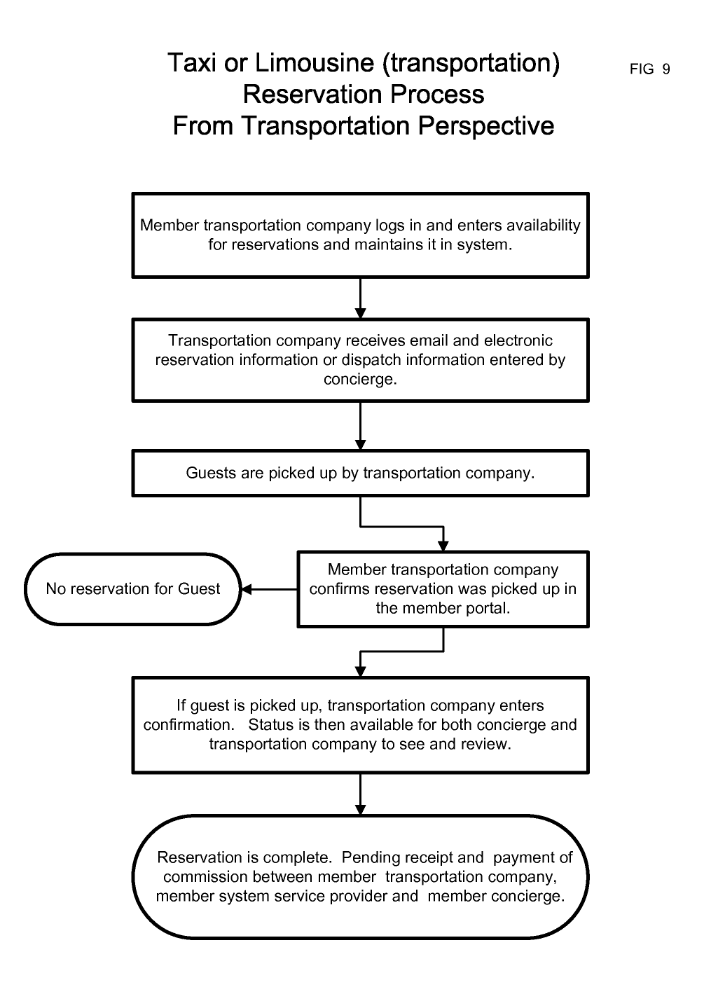

FIG. 10—Golf or other activities Reservation Process from the Concierge Perspective—This figure describes the process from a guest talking with the member concierge describing their desires, to member concierge logging into the system, checking availability of the desired member services, making a reservation with core information regarding the guest and providing the guest with directions or other information regarding their reservation.

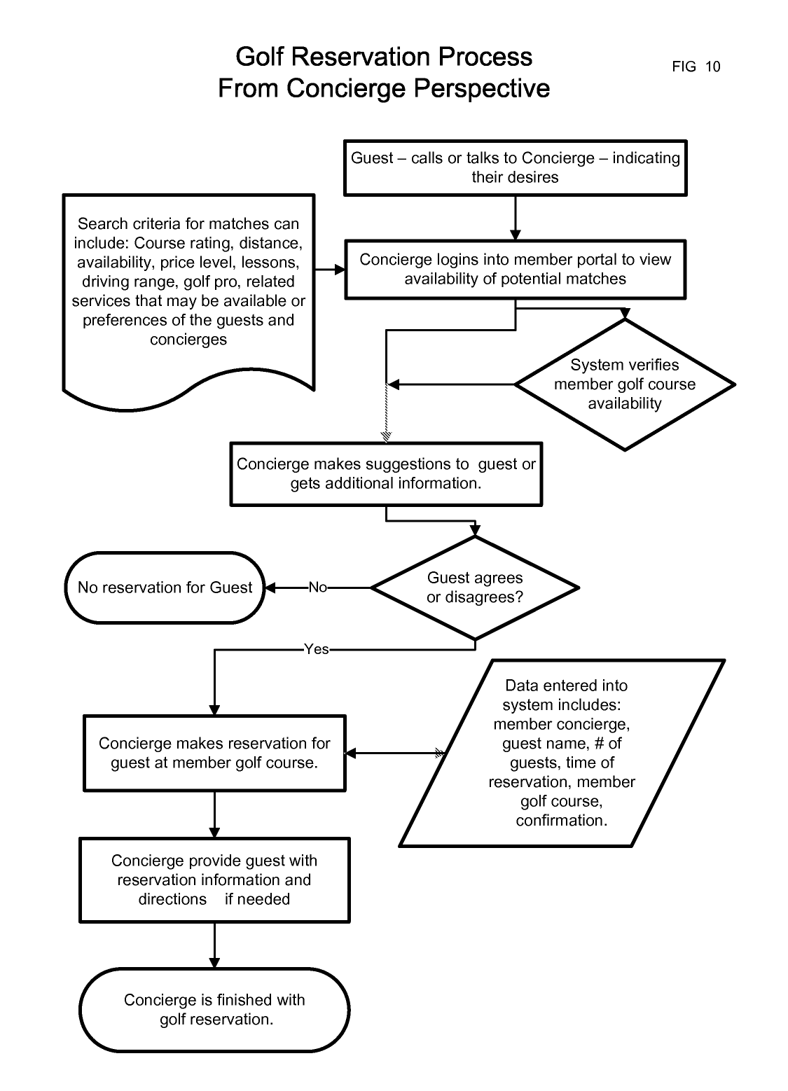

FIG. 11—Golf or other activities Reservation Process from the Golf Course Perspective—This figure describes how the member golf course logs into the invention system or provides invention system with information regarding the member golf course availability at various times to service member concierges referred guests. The member golf course receives an electronic reservation through the system indicating key information of the referred guests and time of the reservation. The member golf course may also receive an email, text message or fax regarding the upcoming reservation. The member golf course then goes into the invention system to confirm that guests have arrived or not. Confirmation that the guests arrive is critical the referral commission process. Without a confirmation that the guests arrived there is no referral commission.

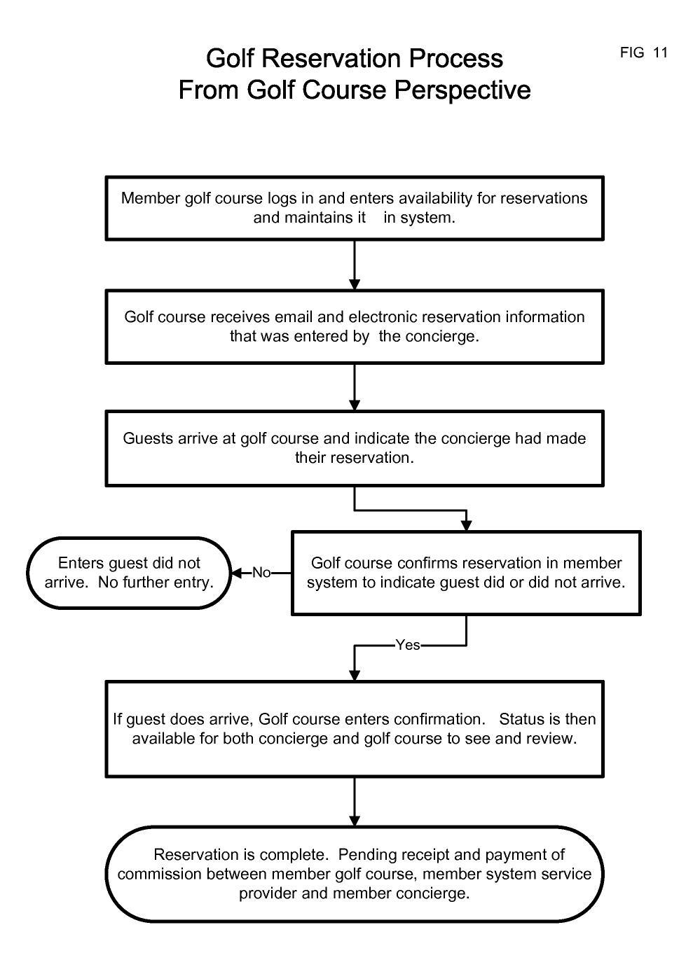

FIG. 12—Reporting of reservations from the member concierge perspective—This figure describes the process of a concierge logging into the system and being able to choose a number of reports that are generally restricted to transactional information that the concierge was a party to. There are options for the concierge to choose summary or detail levels of the information. Summary would generally summarize to a single line per service provider, detail would have a line of data for each transaction/reservation. There are options for changing the dates for the reporting periods and limiting the report to certain types of service providers.

FIG. 13—Reporting of reservations from the member service provider perspective—This figure describes the process of a service provider logging into the system and being able to choose a number of reports that are restricted to transactional information that the service provider was a party to. There are options for the service provider to choose summary or detail levels of the information. Summary would generally summarize to a single line per concierge, detail would have a line of data for each transaction/reservation. There are options for changing the dates for the reporting periods and limiting the report to certain types of service providers.

### DETAILED DESCRIPTION

This invention is to connect member concierges with member service providers in an efficient and effective way so that they can better serve their guests. This invention expands the scope and quantity of member relationships so that members are able to better serve guests, allow member service providers to better communicate availability of services to member concierges, allow member concierges to better understand services available by member service providers, streamline the payments for referral commissions between the members and increase the overall understanding of the mutual business relationship between the members.

Prior art seems to have focused on various forms and processes for obtaining information assistance. But this invention is focused on establishing a member relationship between concierges and service providers in an online efficient manner.

Prior art also has worked with the relationship between retail customers and service providers. They have not focused on the concierge.

### Key Advantages

There are significant advantage to have both parties to a reservation be members to a system. Key advantages include but are not limited to:

Immediate knowledge of the member information because members have previously registered as a member and that information is available through the system, because the system knows who is logged in to the system. The member must be logged in with an active account to be able to participate in this referral reservation process.

Members agree to the terms of the system invention provider. This helps both member concierges and member service providers know that the other members have agreed to follow the terms of the invention system. This helps gives confidence to both members to proceed with referrals between them.

Members have access to reports containing detailed information about reservations between the parties. This allows members to establish ongoing trusting relationships, if members do not act in a trustworthy manner, other members may not want to work with them and they may need to be removed as members of the system. Trusting relationships encourage ongoing referral business between the members because it is advantageous to both members to have this relationship.

Speed with which a member concierge can make a reservation is an advantage. Because both parties are members and availability of the service provider capacity is known in the system, the concierge only needs to input a few key pieces of information regarding the guest to make the reservation. (Key items include: guest name, number of people, date, time, place of reservation. Extra info includes: guest room number, guest phone number, special instructions such as a birthday, private room or preferred location, and anything else that could be beneficial to provide the guest with a better experience.)

The speed of the internet enables members to have real-time status of activity between the members.

If a member concierge does not know the best answer for a particular request, they may be able to use the easy search functionality within the system to find the appropriate provider of the service. This expands the number of relationships a concierge may use to better serve their guests.

Reporting of transactions and the ability of members to run some of their own reports enables them to easily track trends of reservations between members.

Through membership a concierge is able to efficiently coordinate and support many member service providers, without this system and process a concierge may only have a referral relationship with a few service providers. This system greatly expands the reach of both member concierges and member service providers.

Through membership a service provider is able to efficiently market and establish beneficial membership relationships with many concierges. The service provider is able to provide incentives to the concierges to have the concierges help the service providers have better utilization of their available capacity in providing services.

The member service provider is able to receive information about reservations not only through the online system, but has a choice of receiving email, text messages or faxes as well. All means of communication can be used if desired.

Through membership service providers are able to simplify their payments for referral services from concierges. The service provider makes a single payment to the invention system provider which facilitates the payments to multiple concierges.

Through membership the concierges are able to simplify and better track their receipt of referral commissions. A single payment from the invention system provider will cover all the member service provider referral commissions for a period of time.

Through membership and the system of the invention system provider, the service providers are able to more efficiently communicate and market to a broader set of concierges. The member service providers are able to input special incentives for referral commissions that member concierges in the area will be able to see and take advantage of Examples could include early bird restaurant reservations or twilight golf reservations.

A common place to store guests' comments about their experience with the member service provider can be beneficial. Concierges can input these comments into the system when the guests provide them. The concierge have a choice of making some of the comments private to just them or available to all concierges and service providers.

### Disadvantage

A potential disadvantage to the system and having membership is that concierges have been receiving cash or other items of value that may not have been reported as income to the concierges. The loose ad hoc relationships between concierges and service providers are wide spread in this industry. This underground economy may have provided income to concierges with no income tax. At the same time, service providers may have received a referral from a concierge and intentionally chose not to provide any kind of referral commission, even though there was an agreement between them. This new invention system process will report referral commissions to concierges as income. And will provide visibility to transactions between the parties.

### Sign-Up Process for Concierge

The process for signing up as a member concierge is generally quite simple. There are a few key steps including:

Concierge goes to the website and requests to be a member.

Concierge must indicate that they work as a concierge and provide information about the hotel or other establishment that sponsors their concierge services.

Concierge is given information about the rules of membership.

Concierge must accept the rules of membership.

Concierge must provide key information about themselves including taxpayer identification numbers.

Concierge establishes a username and password in the system.

System validates the username uniqueness immediately. If not unique the concierge must pick another username.

Once the system performs initial validation, the concierge is a member and can make reservations within the system.

Other validation of the concierge information will take place within the next few days by people working with the system provider. This may including validating the tax id number provided matches with the name, validating with the sponsor if the sponsor requests validation, validating that the sponsor exists and the addresses are accurate.

Some concierge sponsor organization may have additional requirements that they want. For example a hotel that has several concierges may require that they approve all concierges that sign up. Also all referral commissions might need to be paid to the sponsoring organization. If these rules are not followed in certain organizations they will not allow concierges to use the system invention.

### Sign Up Process for Service Provider

The process for signing up as a member Service Provider is as follows:

Service Provider goes to the website and requests to be a member service provider.

Service Provider needs to be in the business of providing services to patrons that are regularly referred to them by concierges.

Service Provider is given information about the rules of membership.

Service Provider must accept the rules of membership.

Service Provider must provide key information about them.

Service Provider must choose a username that is unique, plus a password.

System validates the username uniqueness immediately. If not unique the service provider must pick another username.

After information is completed the system service provider can approve or reject a service provider's membership request.

The system service provider may request that the service provider sign a contract for membership and may have a membership fee associated with joining with the system service provider. Validation of address, websites, rates, lists of other individuals that can represent the member service provider are all important to make sure the member service provider can be properly represented by the system invention and understands the rules of the relationship.

Once the service provider has been approved by the system service provider, the member service providers will have access to the system to enter their availability and then member concierges will be able to make reservations with the new member service provider.

There is a process within the system to allow members to maintain their profile information. The profile information is slightly different between a member concierge and member service provider. The concierge profile administration screens allow the member concierge to potentially update the following:

### Concierge Profile Maintenance

Name of concierge

Email address of concierge

Address of concierge (home)

Phone numbers (work, mobile, other)

Name of hotel or sponsor establishment where concierge services are rendered.

Address of hotel or sponsor establishment.

Name of contact person at establishment that may oversee concierges

Contact person's phone number that oversees concierges.

Email address of contact person

Website of establishment

Status of relationship between concierge and hotel or establishment.

End date of relationship with the establishment.

Ability to allow the concierge to list more than one establishment.

Update password

Update email address

Request update to Tax ID number

Request updates to payment account

Request other changes or updates

### Service Provider Profile Maintenance

Similar to the concierges, the service providers have profile administration screens that allow the member service provider to potentially update the following:

Name of service provider

Address of service provider

Phone numbers (work, mobile, other)

Name of contact at service provider.

Role of contact at service provider.

Additional contacts at service provider.

Email addresses of additional contacts at service provider.

Roles of additional contacts at service provider.

Website of the service provider

End date of a contacts relationship with the service provider.

Status of service provider.

Update password

Update email address

Types of services provided

Request updates to payment account

Other special information or documents

Request other changes or updates

Service Providers want to store other pieces of information that the member concierge could use to search on. The screens are different for different types of service providers. Some examples for type of service providers that are called out in the system invention include:

### Additional Information the Restaurant Service Provider May Store

Type of food served (American, Chinese, Mexican, Italian, buffet . . . )

Catering services available

Entertainment options (live band, music, dinner show, dancing . . . )

Bar (sports, TV options . . . )

Reservations required/suggested (generally only service providers that request and accept reservations will sign up as member service providers.)

### Additional Information the Golf Service Provider May Store

Type of course (rating), number of holes available,

Practice range

Availability of lessons (group or private)

Name of the Pro

Practice putting area

Available food options (restaurant, walk up options, bar . . . )

### Additional Information the Transportation Service Provider May Store

Transportation Services—

Taxis, Limousines, Buses

Single direction or round trip options

Shuttle options (private or group)

### Additional Information a Sponsor Service Provider May Store

Some hotels or concierge sponsors request that they have the ability to maintain the relationship with the concierges that work at their establishments. If this is the case the manager of the concierges is able to update the status of the concierges that are listed under their establishment. Below is a listing of many of the fields this manager of concierges will be able to update:

Name of the hotel or sponsor

Address of the hotel or sponsor

Phone numbers of the hotel or sponsor

Contacts, phone numbers, roles and email addresses of individuals at the hotel or sponsor including supervisors of concierges and concierges.

Status of the relationship between the hotel or sponsor and the concierges.

Update hotel or sponsor administration passwords

Update listed website that identifies the services that they may provide.

### Availability and Quantity of Guests

The member service providers have the ability to indicate their availability and quantity of guests that they can provide services to at various times of the day. This can be accomplished in several ways depending on what the service provider desires. Below is a list of options:

If the member service provider has a computer system that stores their availability for reservations, the system provider has abilities to create computer interfaces to the member service provider's system to have access to availability information and make it immediately available for concierges to view when making reservations.

The system invention has the ability for the member service provider to easily create and update templates of availability. These templates can be copied from day to day or templates for certain days of the week that have different demands. These templates can then be accessed through the system to view the availability at different times. These templates would provide the expected availability. The system would then track how much of the availability has been used for the given time and day, so that the system would know the remaining availability. This is a fairly easy way for service providers to allocate a certain amount of availability to concierges without having their own electronic system for tracking reservation.

Some member service providers may just want to say that they are accepting or they are not accepting referral reservations. This is a very simple on or off option within the system. The member service provider would be able to update the on off option as often as necessary for their establishment.

### Location and Distance

A function of the system is to know the distance from a member concierge's location to various service providers. This invention system stores distances between member concierges and member service providers within various ranges depending on the area. Usually a range of up to 50 miles is available.

An example of how this works—at the time a concierge or service provider signs up as a member, they include their address information. The system takes this address information and the collects the distance information from various map programs that are available over the internet and stores this distance information in the system so that it can be searched and reported. Thus a guest could request from a concierge to know service providers within a certain number of miles from their location. Having the distance already in the system allows for this search.

The system invention also stores key points of interests and the distances to various member service providers within a few miles of the key point of interest. Key points of interests are valuable to guest that may be planning to spend the day away from their hotel. They may be planning to spend the day at a beach, amusement park or museum, but would like to have reservations at a service provider close to that key point of interest. The locations of the key points of interest are entered into the system with their address and then system determines member service providers within a range of the point of interest.

Often guests request maps to various service providers. This invention stores the addresses and distances between concierges and service providers. This information can be easily passed to various internet mapping services and immediately receive back a map and driving directions. The local knowledge of the concierge may be requested to enhance or replace this information. For example, the concierge may be able to explain parking options or might know if a road is closed or at certain times of the day it is best to avoid certain roads. This local knowledge is why people often consult with concierges.

### Additional Member Information and Documents Stored

Often guests request to see menus or other additional information about the service providers. As part of the service provider sign up process and maintenance of key information, the member service providers are able to store their website link. This website link is available to concierges after they have selected a service provider. Thus the concierge has easy access to the service provider's website.

Service providers are also able to store a few documents as part of their information. For example maybe the service provider does not have a website or wants to make available other information to the concierges. The service provider could load this information to system. Maybe a restaurant wants to store their menu or a golf course may want to store score cards or ratings. It could be that service providers want to store other specials just for the concierges to know about. For example there may be a unique dinner show option during a given time period, or there may be bonus referral commissions for certain times or events.

### Variable Referral Commissions

The invention system has the ability for service providers to indicate that are certain times they are willing to offer bonus referral commissions to the concierges. As an example, a given restaurant may be willing to offer $2 per person to be shared between the system provider and the member concierge for a reservation after 9:00 pm versus $1 per person at 7:00 pm. The member service provider has screens within the system to let them indicate their availability and capacity for reservations. They also have options to let them enter the amount for a referral commission offered at different times. When the member concierge sees this type of information, it may influence the concierge to encourage the reservation for 9 pm instead of 8:30 pm. This helps the service provider better balance their available capacity and provide the guests superior service.

### Restaurant Reservation Steps

The steps for a reservation including the following:

A guest will either call or visit with the concierge indicating they have a desire for some type of service and asks the concierge for recommendations. Below is an example of the restaurant reservation process.

After the guest identifies the type of restaurant, price range, time or other factors, the concierge logs into the system and will either search by the guest's criteria or just know the right restaurant for the guest based on the concierges experience in the local area and helping past guests.

Either through the search of just picking the restaurant within the system, the concierge is able to verify the availability of the member restaurant within the system.

Assuming the member restaurant is available at the requested time, the member concierge asks the guests if it would be alright to assist the guest with making a reservation.

The concierge is then able to go to the reservation screen and input just a few pieces of key information. The few pieces of information include the guest's name, number of people in the party and the time of arrival. The concierge can also add extra info, but is not required to. Extra information may include: the guest's room number, their cell phone number, or any special instructions for the restaurant. Some of the special instructions may be about birthdays, anniversaries, preferred location within the restaurant, type of table or any number of things that would help to make the experience for the guest better.

The concierge then provides the guest with information about their reservation including the time, the restaurant and the number of people. The concierge may also offer the guests maps, driving directions or even a copy of a menu from the restaurant.

After the member concierge submits the reservation, the member restaurant receives information through the system that there is a new reservation for this particular guest that was requested by the particular concierge. The restaurant also may receive this notice of this reservation information through email, fax, text message or through the direct interface to their reservations system or another means.

When the guests arrive at the member restaurant, they let the restaurant know who they are and that there should be a reservation for them.

The restaurant welcomes the guests and verifies the existence of the reservation. The member restaurant should go into the system invention and indicate that the guests have arrived.

Hopefully the member restaurant confirms the reservation in the system at the time the guests arrive, but if not the member restaurant has a period of time to confirm the reservation in the system.

For member service providers that have an online reservations system that they are already using, the system provider will work to provide direct interfaces to these systems and the system invention. These direct interfaces basically make it so both the system provider and the restaurants reservation system can pass key information back and forth electronically between the systems. By having these direct interfaces between the systems it will improve the accuracy of availability of services, the confirmation that services were provided and make it so that member service providers do not need to login to the system provider system to confirm reservations. The service provider only needs to keep the information in their current system, but it will pass the appropriate information back the system invention provider. This will improve the accuracy of the information if this work is all done in the restaurants regular reservation system.

If the member restaurant does not confirm the reservation, the unconfirmed reservation will show on their unconfirmed reservations report in the invention system.

As soon as the member restaurant confirms the reservation, the member concierge would also be able to see that the reservation was confirmed. The member concierge will also be able to see unconfirmed reservations.

On a set schedule the invention system provider will be providing the member restaurant a report/invoice for the confirmed reservations to be paid. Note; the member restaurant can always review the pending unpaid confirmed reservations within the invention system.

On a set schedule the member restaurant will then arrange payment to the invention system provider.

On a set schedule the invention system provider will provide a report and payment to the member concierges for the reservations they have entered and have been confirmed by the member restaurants.

If a member restaurant does not confirm a reservation there will be no obligation for payment.

An important part of this invention is the reporting for both parties to the reservation. This reporting helps to establish a long term beneficial relationship among the members to this system invention. If the member restaurant regularly does not confirm reservations for guests that actually patronize the restaurant, the member concierges may recognize a pattern. This pattern could influence the concierge with regards to referring future business to the restaurant. It is in the restaurant's best interest to be honest in their confirmation of reservations.

Through the reports, the member restaurants can easily measure the effectiveness of various concierges in providing referrals. They will be able to measure the effectiveness of influencing the quantity of reservations and the quality (influencing guests to preferred times of the day.)

The member restaurants will also be able to measure the effectiveness of the invention system in providing referral business to their restaurant from all concierges in the local area.

A similar reservation processes exist for providing reservations for other services, such as golf or transportation services.

### Reporting for Members

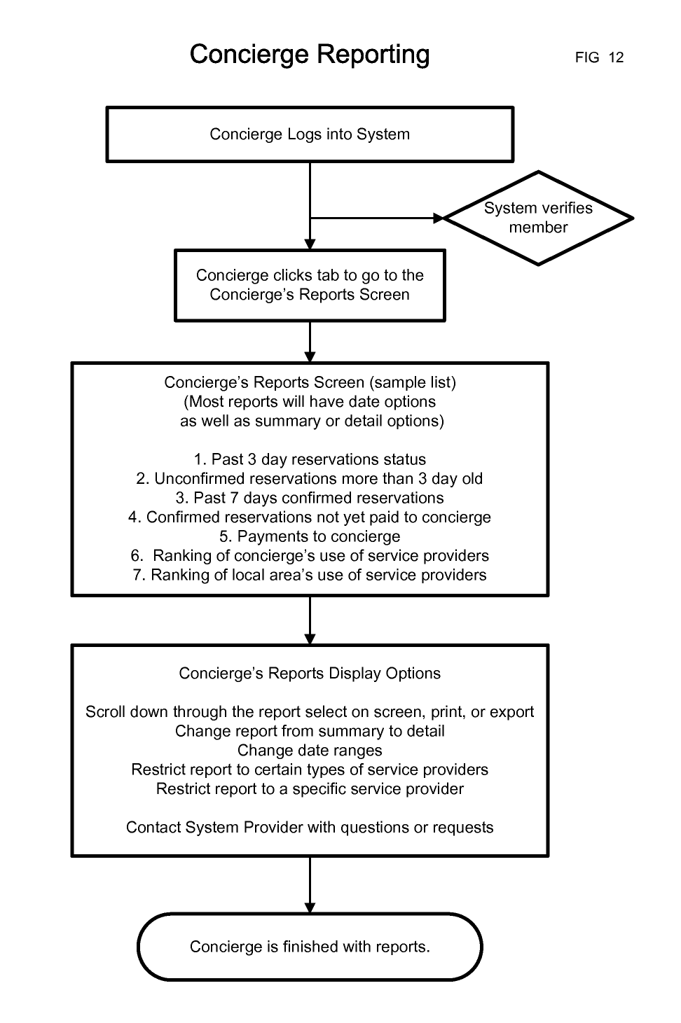

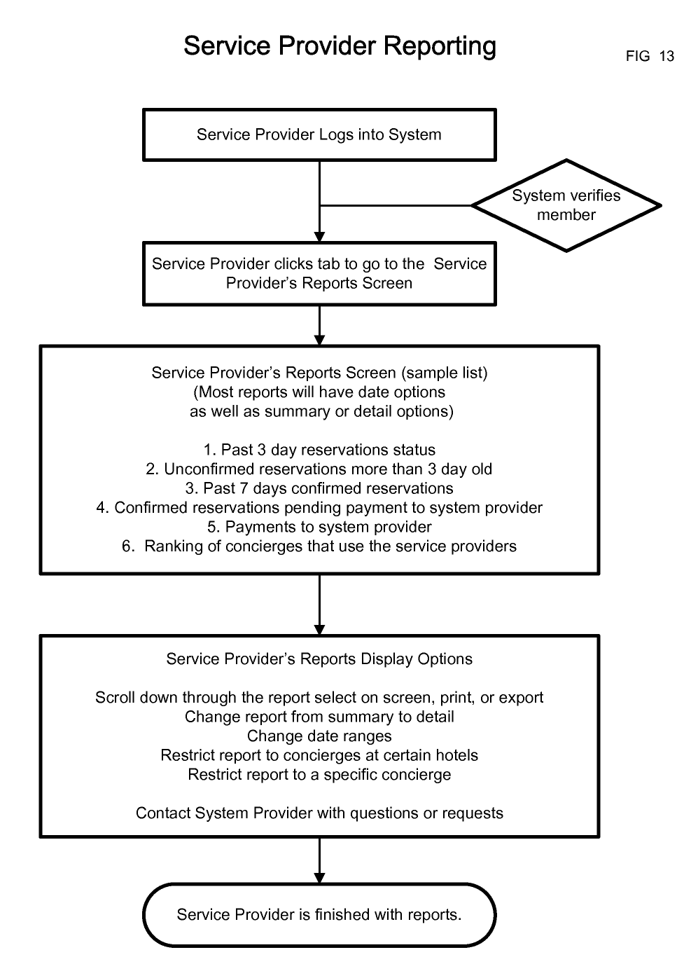

FIGS. 12 and 13 quickly described reports available to parties to this invention system. Reporting is a key portion of this invention. Security to reports and data is also a significant trust factor. All reports regarding transactions within the system have the data restricted in a particular report to only transactions that included that particular member party. For example, a member concierge will only be able to see transactions that they initiated in the system. They will not be able to see other concierge transactions. The member service provider will only be able to see transactions that included them as a service provider. They will not be able to see other service provider transactions or information.

Reports are available in several forms. Reports can be viewed in the system. Through the web, the report information will be displayed on the computer screen. Reports are exportable to .csv or other formats to be downloaded. Reports are also available in a .pdf format. The reports can also be set up to be emailed to the member requestor. Certain requested reports can be scheduled to be emailed to the member requestor on a regular basis.

Security to data, reports and system will be handled in a variety of ways.

Only members will have a login to the system.

There will be no guest logins to the system.

Members will only be able to see transactions that they were a party to.

The system will monitor the types of reports requested to see if there is any inappropriate requests.

### Referral Commission Process

Referral commissions between the member service providers, invention system provider and member concierges is key to this system invention.

Through membership the system provider is able streamline the process for referral commissions between the parties. This is accomplished with the invention system in between the many parties. It was not efficient for the service providers to contact and have arrangements will all concierges, just as it was not efficient for the concierges to try to have arrangements with all service providers. However it is efficient for a 3^{rd} party, like the system invention provider to have contact and membership relationships with many concierges and many service providers.

A key element of the relationship between all the parties is to assure the service providers and concierges that the majority of all referral commissions collected are distributed to the concierges. The concierges are in a position to influence referrals and reservations to service providers. If the system service provider does not distribute a substantial majority of the referral commissions to concierges, the concierge's will have a reduced interest in using the system. Also service providers will be hesitant to sign up as members because they want the majority of the funds going to the people helping provide referrals to their business.

Referral Commissions will vary. The member service providers are in the position to determine what the gross referral commission will be for a given reservation at a given time. The system will take this offered gross commission and display to concierges an estimated referral commission to the concierge. The difference will be for the system service provider to provide the system, administer the collection funds from the member service providers, and administer the payment of funds to the member concierges.

The invention system provider may request that there be certain minimum referral commissions. Part of this is a natural process in that only service providers that provide medium and higher priced services will likely even sign up to be members. These types of establishments would be willing to always pay a nominal minimum referral commission.

Member Service Providers will be provided regular reports indicating the amount of the referral commissions that are coming due based on confirmed reservations. Member service providers will be responsible to make payments to the system service provider.

The system service provider will pay the member concierges after the receiving payment from the member service providers.

### Actual Spend by Guests

The system has a feature to allow the member service provider to enter the amount actually spent by the guests at the service provider. This feature is not required to be used. But can be used to offer a more complete picture of the actual spending of the guests referred by the concierge. The referral commission can also be based off this actual spend number. Generally members find that it is adequate to generally estimate the value of the referrals by using averages of guest that patronize the establishment, without going to the added work of entering the actual spend.

The system provider is working to establish direct interfaces to several different service providers' reservation systems. For reservation transactions that are done directly through interfaces between the system provider and the service providers' reservation system, it may allow for capture of this spend amount. Often restaurant reservations systems include the functionality to include the gross charges for the table of a given party. This information can then be easily passed back the system provider to provide a more accurate guest spend information, which can be used to influence the referral commission depending on how the particular member service provider chooses to pay referral commissions.

### SUMMARY

It is expected that as this system is used there will be other enhancements to this system and the process of providing service between member concierges and member service providers. Currently there does not appear to be other patent art that describes a membership relationship between concierges and various service providers that uses a system invention to efficiently connect many concierges with many service providers. This system invention facilitates the easy creation of reservations, confirmations of reservations, receipt and payment for referral commissions in a systematic way between many parties that have previously had a limited ad hoc relationship.

1. A method for signing up member concierges and member services providers to agreed upon terms for the arranging of concierge type services, such as restaurant reservations, transportations services, golf reservations and other services between members through the use of a secure online member service. Member profiles are stored within the system for use to speed up the reservation and related available member processes.

2. Agreed upon member terms include referral commission information between members, standard processes and procedures, as well as other activities to promote the ongoing efficient working relationship between the member concierge, the member service provider and the member system invention provider. Members are able to securely review and report on the transactions that they were a party to and verify the applicable commission.

3. The system invention can connect with several reservation systems that are currently being used by various service providers.
